(19) United States
(12) Patent Application Publication
(10) Pub. No.: US 2015/0180101 A1
(43) Pub. Date: Jun. 25, 2015

(54) STORAGE CELL SYSTEM

(71) Applicant: SANYO Electric Co., Ltd., Moriguchi-shi, Osaka (JP)

(72) Inventors: Momoko Harada, Hyogo (JP); Toshihiro Sakatani, Hyogo (JP); Hiromasa Sugii, Hyogo (JP); Makoto Ochi, Hyogo (JP); Ryuji Kawase, Hyogo (JP)

(73) Assignee: SANYO Electric Co., Ltd., Moriguchi-shi, Osaka (JP)

(21) Appl. No.: 14/415,345

(22) PCT Filed: Sep. 24, 2013
(86) PCT No.: PCT/JP2013/005630

§ 371 Date: Jan. 16, 2015

(30) Foreign Application Priority Data
Sep. 25, 2012 (JP) 2012-210314

(51) Int. Cl. H01M 16/00; H01M 10/30; H01M 4/32; H01M 10/26; H02J 7/00; H01M 4/24

(52) U.S. Cl. CPC H01M 16/00; H02J 7/0003; H01M 4/242; H01M 4/32; H01M 10/26; H01M 10/30; H01M 2004/028

(57) ABSTRACT

An alkaline storage battery comprises a nickel positive electrode having nickel hydroxide as the main positive electrode active material, a hydrogen absorbing alloy negative electrode having a hydrogen absorbing alloy as the negative electrode active material, a separator, an alkaline electrolyte, and an outer can storing the nickel positive electrode, the hydrogen absorbing alloy negative electrode, the separator, and the alkaline electrolyte, and the hydrogen absorbing alloy is expressed by general formula LaₓRe_{y}Mg_{1-x-y}Niₙ₋ₐMₐ (Re is at least one element selected from rare earth elements including Y, Re is not La, M is at least one element selected from elements other than Co and Mn), and the alkaline electrolyte contains at least one type of compound selected from a tungsten compound, a molybdenum compound, and a niobium compound, and in a system, the alkaline storage battery and a lead battery are connected in parallel.

### TECHNICAL FIELD

The present invention is related to a storage battery system suitable for an idle stop usage.

### BACKGROUND ART

At present, a lead battery is used for a battery of an idle stop system or an regenerative charging system. Moreover, a storage battery system where the lead battery is connected to a secondary battery in parallel, is considered for a high functionality to improve the long life of the lead battery and a fuel efficiency. The secondary battery is required to be installed in the engine room, and as the secondary battery to withstand a high temperature environment of the engine room, a nickel hydride battery attracts attention. (for example, patent literature 1)

### CITATION LIST

### Patent Literature

Patent Literature 1: Japanese Laid-Open Patent Publication No. 2007-258075

### SUMMARY OF THE INVENTION

However, when the lead battery is connected to the conventional nickel hydride battery in parallel and such a storage battery system is continuously used in the high temperature environment corresponding to the engine room, the expected high temperature durability performance is not obtained, and a problem that a degradation of the lead battery is accelerated occurs.

For the purpose of solving such drawbacks, a storage battery system of present disclosure comprises a lead battery and an alkaline storage battery being connected in parallel with the lead battery, and the alkaline storage battery comprises a nickel positive electrode having nickel hydroxide as the main positive electrode active material, a hydrogen absorbing alloy negative electrode having a hydrogen absorbing alloy as the negative electrode active material, a separator, an alkaline electrolyte, and an outer can storing the nickel positive electrode, the hydrogen absorbing alloy negative electrode, the separator, and the alkaline electrolyte, and the hydrogen absorbing alloy is expressed by general formula LaₓRe_{y}Mg_{1-x-y}Niₙ₋ₐMₐ (Re is at least one element selected from rare earth elements including Y, Re is not La, M is at least one element selected from elements other than Co and Mn), and the alkaline electrolyte contains at least one type of compound selected from a tungsten compound, a molybdenum compound, and a niobium compound. Then, the storage battery system which suppresses the occurrence of the inner short circuit and is excellent in the durability can be provided.

Here, it is preferable that a mass of metallic element of the at least one type of compound selected from a tungsten compound, a molybdenum compound, and a niobium compound which the alkaline electrolyte contains, is 20 mg or more per the alkaline electrolyte 1 g, and 50 mg or less per the alkaline electrolyte 1g. Further, it is preferable that an amount of sodium (Na) containing the alkaline electrolyte is 1.0 mol/L or more and 4.0 mol/L or less.

When the lead battery is connected to the conventional nickel hydride battery in parallel and such a storage battery system is continuously used in the high temperature environment corresponding to the engine room, the expected high temperature durability performance is not obtained. As the storage battery system of the present disclosure is used in the high temperature environment corresponding to the engine room, the conventional nickel metal hydride battery for a vehicle using a hydrogen storage alloy of the negative electrode which contains Co, Mn, the formed conductive pass becomes apparent by these elements precipitated on the positive electrode plate, and the internal short circuit occurs.

Since this makes not only the nickel metal hydride battery unable to be used, but also the charge state of the lead battery connected in parallel decreased, the lead battery is remarkably degraded, and this degradation is prevented by the system of the present disclosure. Therefore, the nickel metal hydride battery using a hydrogen storage alloy which does not contain Co, Mn is indispensable to the system of the present disclosure.

Further, when the storage battery system is charged and discharged repeatedly at a high temperature atmosphere, a charging efficiency performance of the nickel metal hydride battery is decreased. In order to suppress this performance decrease, the alkaline electrolyte contains at least one type of compound selected from a tungsten compound, a molybdenum compound, and a niobium compound. This can largely improve the durability of charging and discharging in the storage battery system.

By the above configuration, the storage battery system having a high temperature durability performance is provided such that it is endurable even in the installation inside the engine room.

### BRIEF DESCRIPTION OF DRAWINGS

FIG. 1 is a schematic sectional view of an alkaline storage battery used in the present invention or the comparative example.

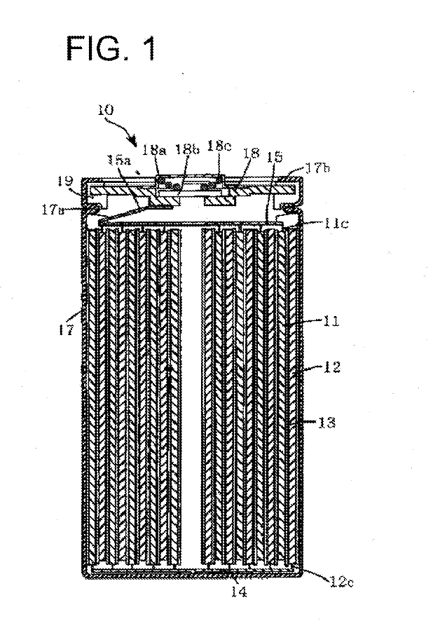

### DESCRIPTION OF EMBODIMENTS

Hereinafter, embodiments of the present invention will be described in detail. However, the present invention is not limited to the embodiments. the present invention can be equally applied to various modified ones without departing from the technical spirit described in the claims.

### 1. Nickel Positive Electrode Plate

A nickel positive electrode 11 of the present disclosure was prepared by filling pores of a nickel sintered substrate with an active material in particular amounts. In this case, the nickel sintered substrate used was prepared as below. For example, methylcellulose (MC) as a thickener, polymeric hollow microspheres (having a pore size of 60 μm, for example), and water were mixed with nickel powder, and the mixture was kneaded, thus preparing a nickel slurry. Next, the nickel slurry was applied to both faces of a punching metal using a nickel plated steel plate. Subsequently, the coated plate was heated in a reducing atmosphere at 1000° C., thereby removing the thickener and the polymeric hollow microspheres and sintering the nickel powder. Consequently, the nickel sintered substrate having a porosity of about 85% was obtained. Here, the porosity was measured using a mercury porosimeter (PASCAL 140 made by Fisons Instruments Inc.).

Next, the obtained nickel sintered substrate was immersed in the impregnating solution prepared by mixing nickel nitrate, cobalt nitrate, and zinc nitrate. Next, this nickel sintered substrate was immersed and reacted in an alkaline solution (for example, an aqueous sodium hydroxide (NaOH) solution). Nickel hydroxide, cobalt hydroxide, and zinc hydroxide were made within pores of the porous nickel sintered substrate. Next, the substrate was sufficiently washed with water, and then dried. Such a series of positive electrode active material filling operations were repeated seven times to fill the porous nickel sintered substrate with a predetermined amount of the positive electrode active material mainly containing a nickel hydroxide. And then the nickel sintered positive electrode plate was obtained.

### 2. Hydrogen Storage Alloy Negative Electrode Plate

A hydrogen storage alloy negative electrode 12 was prepared by applying a hydrogen storage alloy slurry to a negative electrode substrate formed using a punching metal. A hydrogen storage alloy powder was prepared in the following way. In this case, for example, lanthanum (La), neodymium (Nd) as 100% by mass, magnesium (Mg), nickel (Ni), and aluminum (Al) were mixed in a predetermined molar ratio. Next, the mixture was placed in a high-frequency induction heater to be melted, and then rapidly cooled to prepare a hydrogen storage alloy ingot expressed by a general formula of LaₓRe_{y}Mg_{1-x-y}Niₙ₋ₐMₐ (Re is at least one element selected from rare earth elements (excluding La): Nd, Sm, Y, or the like, and M is at least one element selected from Al, Co, Mn, Zn). The thermal treatment was carried out in the obtained hydrogen storage alloy ingot at a temperature by 30° C. lower than a melting point of the hydrogen storage alloy during a predetermined time (10 hours in this case).

After that, the obtained hydrogen storage alloy ingot was roughly pulverized, and then the hydrogen storage alloy was mechanically pulverized in an inert gas atmosphere, and particles of sizes between 400 mesh to 200 mesh were sifted out. Here, this powder was analyzed by a laser diffraction/scattering particle size analyzer to determine its particle size distribution. As a result, the particle size obtained at the mean value of weight was found to be 25 μm which indicated 50% of mass integral. Then the powder of the hydrogen storage alloy was obtained.

Then, 100 parts by mass of the obtained hydrogen storage alloy powder was mixed with 0.5 part by mass of styrene butadiene rubber (SBR) as a water-insoluble polymer binder, 0.3 part by mass of carboxymethyl cellulose (CMC) as a thicker, and an appropriate amount of pure water and the whole was kneaded to prepare a negative electrode active material slurry. Next, the obtained negative electrode active material slurry was applied to both sides of a negative electrode core substrate made from a punching metal (made from a nickel coated steel plate). Then, the substrate was dried and rolled so as to have a predetermined packing density, and cut into a predetermined size to prepare the hydrogen storage alloy negative electrode plate of A and B of alloy composition described in the following

negative electrode plate A La_{0.4}Nd_{0.5}Mg_{0.1}Ni_{3.5}(Co,Mn)_{0.1}Al_{0.1}(n=3.7)

negative electrode plate B La_{0.4}Nd_{0.5}Mg_{0.1}Ni_{3.5}Al_{0.2}(n=3.7)
3. The alkaline electrolyte which was injected into an electrolyte outer case is explained in the following. A tungsten compound was added to a mixed aqueous solution of potassium hydroxide (KOH), sodium hydroxide (NaOH), lithium hydroxide (LiOH) to be a predetermined mole ratio. This alkaline electrolyte was used. In this case, tungsten is added to be 20 mg to 50 mg per 1 g of the alkaline electrolyte. By the above, the electrolyte a to the electrolyte e were prepared as shown in Table 1.

| | alkaline | KOH | NaOH | LiOH | W |
|---|---|---|---|---|---|
| | mole ratio | mole ratio | mole ratio | mole ratio | amount |
| electrolyte a | 7.0 mol/L | 6.1 mol/L | 0.7 mol/L | 0.2 mol/L | no |
| electrolyte b | 7.0 mol/L | 6.1 mol/L | 0.7 mol/L | 0.2 mol/L | 20 mg |
| electrolyte c | 7.0 mol/L | 6.1 mol/L | 0.7 mol/L | 0.2 mol/L | 50 mg |
| electrolyte d | 7.0 mol/L | 3.8 mol/L | 3.0 mol/L | 0.2 mol/L | 50 mg |
| electrolyte e | 7.0 mol/L | 2.8 mol/L | 4.0 mol/L | 0.2 mol/L | 50 mg |

### 4. Nickel Metal Hydride Battery

The above prepared nickel positive electrode plate 11 and hydrogen storage alloy negative electrode plate 12 were wound in a spiral interposing a separator therebetween, and then a spiral electrode assembly was made. Here, a core substrate exposed portion 11c of the nickel positive electrode plate 11 was exposed at the top portion of the spiral electrode assembly, and a core substrate exposed portion 12c of the hydrogen storage alloy negative electrode plate 12 was exposed at the bottom portion of the spiral electrode assembly.
A negative electrode current collector 14 was connected by welding to the core substrate exposed portion 12c exposed at the bottom surface of the spiral electrode assembly, and a positive electrode current collector 15 was connected by welding to the core substrate exposed portion 11c exposed at the top surface of the spiral electrode assembly, and then the electrode assembly was obtained.

The obtained electrode assembly was stored into an outer can 17 (the outer surface of the bottom surface is a negative external terminal.)which was made of a nickel coated iron and had a tube shape including a bottom portion. Then, the negative electrode current collector 14 was connected by welding to the inner side of the bottom portion of the outer can 17. On the other hand, the current collecting lead 15a which extended from the positive electrode current collector 15 was connected by welding to the bottom portion of a sealing plate 18. Here, the sealing plate 18 had a positive electrode cap 18a. Inside the positive electrode cap 18a, a pressure valve was arranged including a valve element 18b and a spring 18c that deform with a particular pressure. Here, the sealing plate had an insulating gasket on a peripheral part thereof in advance.

Next, an annular groove 17a was formed on the upper peripheral part of the outer can 17. After that, the alkaline electrolyte was poured. An insulating gasket 19 attached at the peripheral portion of the sealing plate 18 was provided on the annular groove 17a formed at the upper portion of the outer can 17. After that, an open end edge 17b of the outer can 17 was caulked. And then a nickel metal hydride battery 10 of a battery capacity 6.0 Ah was prepared. As shown in Table 2, battery A to battery G of the nickel metal hydride batteries 10 were prepared.

The battery A to the battery G prepared in the above were charged with a charging current of 1 lt until SOC (State Of Charge) 120% at 25° C. atmosphere, and rested during 1 hour after charging. Then, they were left as it is for 24 hours at 60° C. atmosphere, and were discharged with a discharging of 1 lt until battery voltages became 0.9 V. This charging and discharging process was repeated two times to activate the battery A to the battery G.

Next, the battery A to the battery G were connected in 10 series respectively, and a battery module A to a battery module G were prepared as shown in Table 2.

TABLE 2

| | | negative | | | | |
|---|---|---|---|---|---|---|
| | | electrode | | electrolyte | | |
| title | | kind | CoMn | kind | NaOH | W amount |
| battery | battery A | A | contained | a | 0.7 mol/L | no |
| module A | | | | | | |
| battery | battery B | A | contained | e | 4.0 mol/L | 50 mg |
| module B | | | | | | |
| battery | battery C | B | no | a | 0.7 mol/L | no |
| module C | | | | | | |
| battery | battery D | B | no | b | 0.7 mol/L | 20 mg |
| module D | | | | | | |
| battery | battery E | B | no | c | 0.7 mol/L | 50 mg |
| module E | | | | | | |
| battery | battery F | B | no | d | 1.0 mol/L | 50 mg |
| module F | | | | | | |
| battery | battery G | B | no | e | 4.0 mol/L | 50 mg |
| module G | | | | | | |

### 5. Lead Battery

As the lead battery 1, the batteries which meet the following performances under the test condition provided by STANDARD OF BATTERY ASSOCIATION OF JAPAN (SBA S 0101) are used.

Capacity per 5 hours: 48 Ah

Rated cold cranking current: 320 A

Acceptability of charging: 6.0 A

### 6. Storage Battery System

The lead battery and each of the nickel metal hydride battery modules A to G were connected in parallel after the following treatment.

Under the condition provided by STANDARD OF BATTERY ASSOCIATION OF JAPAN (SBA S 0101), namely, the lead battery 1 was charged with 0.2 lt of charging current, until the terminal voltage measured during charging in 15 minutes time intervals, or the electrolyte density by temperature correction shows a constant value in the 3 consecutive measurements, and after 24 hour leaving in a normal temperature, the voltage of the open circuit was measured.

After the nickel metal hydride battery module was charged with a charging current of 1 lt until 110% of the battery capacity, the n nickel metal hydride battery module were discharged with a current of 1 lt by a predetermined capacity. And after 24 hour leaving in a normal temperature, when the difference of the open circuit voltages between the lead battery and the nickel metal hydride battery module was 0.1V or less, the nickel metal hydride battery module was connected in parallel to the lead battery. Thus, the storage battery systems of comparative example 1 and 2, and examples 1 to 5 were prepared. In addition, a reference example 1 was the lead battery by itself.

### 7. Durability Evaluation

### (1) Evaluation Method

The lead battery and the nickel metal hydride battery module which were adjusted at a predetermined open circuit voltage, were connected in parallel, and the following test was carried. It was charged at the charging voltage of 14V for 60 seconds at 60° C. atmosphere, and discharged at the discharging current of 45 A for 59 seconds, and discharged at the discharging current of 300 A for 1 second, and this charging and discharging procedure was repeated 3600 times, and it was left for 2 days. Further, the above procedure of the durability evaluation test was repeated.

The index value of durability (life of the storage battery system) was determined as the cycle number when the voltage of the storage battery system becomes less than 7.2 V as the discharge end voltage, and the ratio X of the index value to the cycle number of the lead battery by itself was confirmed.

### (2) Evaluation Result

The evaluation result of durability was shown in Table 3.

TABLE 3

| | | negative | | | | | |
|---|---|---|---|---|---|---|---|
| | | electrode | | electrolyte | | | |
| title | configuration | kind | CoMn | kind | NaOH | W amount | X |
| Ref. Ex. 1 | lead battery | — | — | — | — | — | 100 |
| Com. Ex. 1 | lead battery + | A | contained | a | 0.7 mol/L | no | 75 |
| | battery module A | | | | | | |
| Com. Ex. 2 | lead battery + | A | contained | e | 4.0 mol/L | 50 mg | 75 |
| | battery module B | | | | | | |
| Example 1 | lead battery + | B | no | a | 0.7 mol/L | no | 190 |
| | battery module C | | | | | | |
| Example 2 | lead battery + | B | no | b | 0.7 mol/L | 20 mg | 270 |
| | battery module D | | | | | | |
| Example 3 | lead battery + | B | no | c | 0.7 mol/L | 50 mg | 320 |
| | battery module E | | | | | | |
| Example 4 | lead battery + | B | no | d | 1.0 mol/L | 50 mg | 325 |
| | battery module F | | | | | | |
| Example 5 | lead battery + | B | no | e | 4.0 mol/L | 50 mg | 405 |
| | battery module G | | | | | | |

According to the above result, in the comparative example 1, 2 in which the battery module A or the battery module B is connected to the lead battery in parallel, the durability is decreased more than the lead battery by itself. In the battery module A and the battery module B, during charging and discharging at the high temperature, the discharging voltage is decreased by the inner short circuit of the battery, and also the SOC of the lead battery is decreased, and the discharge voltage of the storage battery system is decreased.

In the example 1 in which the battery module C excluding Co and Mo in the negative electrode alloy from the battery module A is connected to the lead battery in parallel, the durability is improved about 2 times more than that of the lead battery by itself. This is a reason why the material which causes the inner short circuit is removed by excluding Co and Mn from the negative alloy, and the durability of this storage battery system is improved more than that of the lead battery by itself since the nickel metal hydride battery decreases the work amount of the lead battery.

In the example 2, 3 of the battery module D, E in which tungsten is added to the battery module C, and which is connected to the lead battery in parallel, the durability is improved by the increase of tungsten up to 50 mg. It is thought that as the addition of tungsten suppresses a decrease of charging efficiency in the positive electrode and the oxygen generation in the positive electrode is decreased, the degradation of the positive and negative electrode materials and the increase of resistance are suppressed.

In the example 4, 5 of the battery module F, G which is connected to the lead battery in parallel, the durability is further improved. It is thought that the increased amount of sodium hydroxide further suppresses a decrease of charging efficiency in the same as the above tungsten.

At this time, data is not shown, and a molybdenum compound, and a niobium compound can obtain the same effect.

### REFERENCE MARKS IN THE DRAWINGS

11: nickel positive electrode plate
11c: core substrate exposed portion
12: hydrogen storage alloy negative electrode plate
12c: core substrate exposed portion
13: separator
14: negative electrode current collector
15: positive electrode current collector
15a: current collecting lead
17: outer can
17a: annular groove
17b: open end edge
18: sealing plate
18a: positive electrode cap
18b: valve element
18c: spring
19: insulating gasket

1. A storage battery system comprising:
a lead battery; and
an alkaline storage battery being connected in parallel with the lead battery,
wherein the alkaline storage battery and lead battery connected in parallel with each other are charged or discharged,
further the alkaline storage battery comprising:
a nickel positive electrode having nickel hydroxide as the main positive electrode active material;
a hydrogen absorbing alloy negative electrode having a hydrogen absorbing alloy as the negative electrode active material;
a separator;
an alkaline electrolyte; and
an outer can storing the nickel positive electrode, the hydrogen absorbing alloy negative electrode, the separator, and the alkaline electrolyte,
wherein the hydrogen absorbing alloy is expressed by general formula LaₓRe_{y}Mg_{1-x-y}Niₙ₋ₐMₐ (Re is at least one element selected from rare earth elements including Y, Re is not La, M is at least one element selected from elements other than Co and Mn), and
the alkaline electrolyte contains at least one type of compound selected from a tungsten compound, a molybdenum compound, and a niobium compound.

2. The storage battery system according to claim 1,
wherein a mass of metallic element of the at least one type of compound selected from a tungsten compound, a molybdenum compound, and a niobium compound which the alkaline electrolyte contains, is 20 mg or more per the alkaline electrolyte 1 g, and 50 mg or less per the alkaline electrolyte 1 g.

3. The storage battery system according to claim 1,
wherein an amount of sodium (Na) containing the alkaline electrolyte is 1.0 mol/L or more and 4.0 mol/L or less.

4. The storage battery system according to claim 2,
wherein an amount of sodium (Na) containing the alkaline electrolyte is 1.0 mol/L or more and 4.0 mol/L or less.
